(19) United States
(12) Patent Application Publication
(10) Pub. No.: US 2002/0183867 A1
(43) Pub. Date: Dec. 5, 2002

(54) Agricultural management system for providing agricultural solutions and enabling commerce

(75) Inventors: Pinaki Gupta, Andhra Pradesh (IN); Krishna Mohan, Andhra Pradesh (IN)

Correspondence Address: Bernhard D. Saxe, Foley & Lardner, Washington Harbour, Suite 500, 3000 K Street, N.W., Washington, DC, 20007-5143, US

(73) Assignee: Nagarjuna Holdings Private Limited

(21) Appl. No.: 10/000,805

(22) Filed: Dec. 4, 2001

(30) Foreign Application Priority Data
Apr. 4, 2001 (IN) PCT/IN01/00085
Apr. 4, 2000 (IN) 252/MAS/2000

(51) Int. Cl. G06G 1/14

(52) U.S. Cl. 700/28; 705/22

(57) ABSTRACT

The present invention relates generally to a networked integrated computer system and more particularly to using web based distributed enterprise computer systems for providing agricultural solutions both technical and commercial for conducting e-commerce, wherein the transactions are between the farmer, who is the central figure in the entire system and the producer and dealer of farm input and the consumer and trader of farm output, and the invention provides methods of creating a virtual marketplace.

### TECHNICAL FIELD

The present invention relates generally to a networked integrated computer system and more particularly to using Web based distributed Enterprise Computer Systems for providing Agricultural Solutions both Technical & Commercial and for conducting E-Commerce. The transactions are between the Farmer, who is the central figure in the entire system and the Producer and Dealer of Farm Input and the Consumer and Trader of Farm Output. Further, the invention provides methods of creating a virtual marketplace.

### BACKGROUND ART

Agricultural business has 5 major players in its business cycle who may be active simultaneously, or at different times: Farmers, Input Company, Input Dealer, Output Company and Output Traders. The farmer is the chief producer of the farm output as well as the chief consumer of farm inputs such as seeds, fertilizers, micro-nutrients, farm equipments, etc. The Input Company is the chief producer of the farm inputs. The Input Dealer is an intermediary between the Input Company and the Farmer or between other Input Dealers. The Output Company refers to an entity who is the chief consumer of the farm output. The Output Trader is an intermediary between the Farmer and the Output Company or between other Output Traders.

In the current scenario, in the absence of a truly Decision Support System, a Farmer grows crops and adopts practices based on his past experience and limited market information. The Farmer is guided by past experiences with respect to adopting or devising strategies for pest control and nutrient management.

Traditionally, the Farmer takes his farm output i.e. the produce to the marketplace wherein the produce is sold either to the Output Company or the Output Trader, who in turn sells the same to the Output Company, thereby earning considerable margins. The transactions are mostly localized since physical meeting is essential. In most of the cases, the Farmer and the Output Company do not interact with each other, on account of the key role being played by the Output Trader. Ideal situations would warrant that the Farmers directly contacts the Output Company for the sale of his produce and the Input Company for the purchase of farm Inputs. With the advent of electronic forms of communication, telegraph, telephone, and more recently digital networks, it has become possible to conduct commerce as well as sharing of databases and obtaining knowledge based solutions using digital computer systems. There are now several packages or tools that integrate all the functions/business processes in a manner that optimizes the cycle time and provides support systems for effective decision making. For instance, U.S. Pat. No. 6,016,713 issued to Case Corporation relates to a site-specific precision farming system for collecting and analyzing soil samples using a vehicle. The invention provides a vehicle provided with a soil analysis equipment for soil sample analysis, at different loci of the farm. The data thus collected by the vehicle is used by the host computer to generate a prescriptive map.

Ag-chem Equipment Co., Inc provides a system for transfer of field data for making product application maps. The software is generally used for soil sampling and soil analysis. The software is also capable of providing field-mapping support.

SST Development Group Inc provides products that give agriculturists, the ability to integrate various components of precision farming technologies for thorough analysis and decision making power.

U.S. Pat. No. 5,751,576 issued to ag-chem Equipment Co., Inc relates to an intention for a system designed for precise application of agricultural products. The system in general, provides information on the soil-type or geologic characteristics of the soil and thereby the agronomic plan. The plan contains recommendations for seed variety or hybrid, planting density, periodic application of one or more fertilizers, herbicides, pesticides or other products at varying rates on densities throughout the field in order to maximize yield.

U.S. Pat. No. 5,897,619 issued to Agri-Peril Software Inc pertains to a crop-insurance management processing system for use by insurance companies. The invention basically deals with acreage and production information systems.

U.S. Pat. No. 5,884,225 relates to a system and method for providing farmers/producers with crop characteristic predictions for standing crops so as to enable farmers to predict optimum harvest times.

Specialized Data Systems provides a software for Farmers and Ranchers. It is a cash farm accounting system with integrated payroll, Enterprize Analysis, and perpetual inventory. Soft Systems Pvt. Ltd. holds a website ewww.softsystemsindia.com that monitors day to day activities covering spheres of budget, payroll, accounts, inventory or production.

FBS System has a site www.fbssystems.com which is a software for management information system having stand-alone and integrated system for accounting. financial analysis, crop and livestock production and farm management.

Linnet-The Land Systems Company has a web site www.croplandsthesystem.com. The Land Systems Company provides a software that supports agricultural business with respect to agronomic consulting, crop inputs, grain acquisition and handling and financial risk management. The software integrates farming practices from soil analysis to harvest. Red Wing's Ag Resource Center (www.redwingsoftware.com) provides an accounting software for tracking and managing on-farm financial operations.

All the above softwares available in the market attend to discrete functions in the chain of agricultural activities. Still, none of the softwares enable transactions of commodities with the Dealers/Traders and the Output/Input companies while at the same time providing crop related information.

Agchemicals.com, farms.com and agriculture.com are sites that enable agri-products trading with the Input or Output companies. However, these sites do not provide any technical information on farming such as soil testing, pest/nutrient management.

Thus, different softwares and systems exist to attend to various components of the agricultural business cycle. Most of these software are also crop-specific centering around soya, corn.

As stated above, most of the software which although fall under the category of agriculture, are more focussed on allied activities of agriculture, like, Farm & Ranch. Thus, most of these softwares do not address the core subject of agriculture or in other words Farm Management.

An ERP (enterprise resource package) is an IT tool which integrates all functions business processes in a manner which optimizes the cycle time and provides support systems for effective decision making, Some examples of ERP are SAP and Baan.

Some of the systems have made an attempt to address some of these components of agriculture, like, Nutrient Management, Pest Management to name a few. In most of these systems the crops addressed are one or at the most a couple. These only act as a repository of information related to their respective areas across the specified crops. It does not provide solutions, which are very precise in the form of site-specific, situation-specific across each individual Farmer.

Another difficulty with most of these software is that they are stand-alone packages and cannot be interfaced with each other. Also, most of them do not allow sharing of the software across multiple users outside an individual's system. Alternate methods, which some of the bigger farm producers use is that of creating a customized package for capturing details of one's activities. There is no interface between each of the farm activities, be it technical or commercial.

The packages currently available can be broadly classified into 4 categories

i. Commerce enabled packages

ii. Packages offering technical solutions

iii. Packages targeted at allied activities of agriculture

iv. Specific purpose standalone packages

There is no package which is web enabled and addressing both:

i. Crop Information, Geographic Information System based along with a Decision Support System

ii. Commerce

Thus, there is an acute need felt by the farming community, of a system which would provide “A Complete Agri Solution” by integrating all the three components of agriculture, namely, INPUT, FARM and OUTPUT having an interface among themselves along with the scope for Commerce. This would help the Farmer remain Competitive, Productive and Profitable through Information, Control and Decision Support.

Therefore, it is desirable to provide a computerized web based system which would not only provide technical solutions spread across various agro-climatic zones covering a gamut of crops but would also act as a Decision Support Tool based on the details captured about all the farm activities on an individual user basis. Added to this, is the scope for Commerce.

### OBJECTS OF THE INVENTION

The main objective of the invention is to provide an agricultural management system that provides agricultural solutions and enables on-line commercial transactions.

Another object is to provide a system that brings the Farmer, the Input Company, the Input Dealer, the Output Company and the Output Trader on the same platform in a virtual marketplace.

Yet another object is to provide a system that not only contains a database of agricultural systems and practices, but also provides site-specific and situation-specific technical and commercial solutions.

Still another object is to provide a system that provides a dynamic environment for crop planning, evaluation, crop performance, farming strategies and financial performance.

Yet another object is to provide a networking system wherein each module is capable of being used independent of the others as a stand alone system on the web or ones own computer and also as a web enabled integrated system.

Still another object is to provide a networking system accessible in several languages.

Another object is to provide a networking system that encourages a Farmer or any user to participate in the network without compromising on the secrecy of protected information each Farmer or Company or Dealer/Trader does not wish the others to access.

Yet another objective is to provide a software enabling agricultural business.

A further objective is to provide methods of performing on-line transactions using the system of the invention.

### DETAILED DESCRIPTION

The invention presents an integrated system that provides agricultural solutions, enables on-line electronic business transactions, said system comprising:

(i) A Farm Management System comprising modules selected from the group of decision support tools consisting of Crop Information System, Budgetary Control, Funds Management, Inventory Management and Sales Management

(ii) Electronic commerce enabling system and

(iii) User interface enabling access to both, the Farm Management System and the electronic commerce enabling system.

In the system, the Farm Management System modules are selected from the group comprising Crop Information System, Funds Management, Sales Analysis, Budgetary Control and Inventory Management.

In the system, the Crop Information module comprises sub-modules selected from the group consisting of seed module, soil module, nutrient module, crop production module, water management module and yield module.

In the system, the Crop Information System/means comprises information relating to soil analysis, seed treatment, sowing, integrated nutrient management, integrated pest management, water and wheat management, bio-metric observations, plant growth monitoring and purchase of farm inputs such as seeds, fertilizers and pesticides.

In an embodiment of the system, the Inventory Management module comprises sub-modules selected from the group comprising input details, farm activities, output details and sales details.

In still another embodiment of the system, Crop Information System provides information selected from suggestion of cropping pattern, schedule of farm operations, forecasting farm operations, cropping patterns, average yield, customized package of practices.

In yet another embodiment of the system Sales Analysis module comprises functions selected from the group comprising sales plan schedule, product-wise sales analysis, cash and trade discounts, customer-wise analysis, output price trends, cost benefit analysis and expected cash flow schedule.

In another embodiment, the Budgetary Control module comprises functions selected from the group comprising variance standard and accounting cost of input for a period, variance standard and accounting cost of labor for a period, variance standard and accounting cost of input for each operation, variance standard and accounting cost of cultivation.

In another embodiment, the Funds Management module comprises functions selected from the group comprising funds requirement schedule, expected cash inflow schedule, funds borrowing schedule, expected cash flow schedule and cost of capital.

In still another embodiment, the Inventory Management module comprises functions selected from the group comprising purchase, scheme of holdings, average holdings and average holding period.

In another embodiment, the users are the Farmer, the Output Company, the Input company, the Input Dealer and the Output Trader.

In yet another embodiment, the central data warehouse is a world wide web server and the communication lines are Internet Lines that connect the different players of the system at their computers to the world wide web server.

In another embodiment, the system is capable of performing transactions between the Input Company and the input Dealer, Output Company and the Output Trader, the Input Company and Farmer, Input Dealer and Farmer, Output Company and Farmer, Output Trader and Farmer

In another embodiment, the system identifies an appropriate match for executing the transaction, in cases no match is identified or at the request of the user. the transactions/quotations are stored in the data-warehouse to be used by the user at a later stage.

The invention also provides a method for providing agricultural solutions and conducting electronic commercial transactions, said transactions being conducted over a computer network, comprising a central data warehouse and a plurality of remote computers/users, and communication lines connecting the remote computers/users to the central system, the method comprising the steps of:

a. registering as a user of the Farm Management System, wherein the system comprises information on decision support tools selected from crop information system, budgetary control, funds management, inventory management and sales management or Electronic Commerce;

b. requesting site specific information from any module of the decision support tool;

c. performing iterations in the database to provide solutions and enabling electronic transactions between users.

In an embodiment, the user account is created in the networking system providing each user a specific account name, identification code and password.

In another embodiment, the user accounts are created by the remote computers prior to using the system.

In yet another embodiment, the system is operable in languages selected from English, Hindi, Telugu, Kannada, Punjabi and Bengali.

In still another embodiment, the central data warehouse is a world wide web server and the communication lines are Internet Lines that connect the different players of the system at their computers to the world wide web server.

In another embodiment, agricultural solutions are obtained though decision support tools comprises Farm Management System module selected from the group comprising Crop Information System, Funds Management, Sales Analysis, Budgetary Control and Inventory Management.

In still another embodiment, agricultural solutions are obtained though decision support tools selected the group of modules comprising Crop Information module which further comprises sub-modules selected from the group consisting of seed module, soil module, nutrient module, crop production module, water management module and yield module.

In yet another embodiment, the Crop Information System comprises information relating to soil analysis, seed treatment, sowing, integrated nutrient management, integrated pest management, water and wheat management, bio-metric observations, plant growth monitoring and purchase of farm inputs such as seeds, fertilizers and pesticides.

In another embodiment, wherein the Inventory Management module comprises sub-modules selected from the group comprising input details, farm activities, output details and sales details.

In another embodiment, the crop information system provides information selected from suggestion of cropping pattern, schedule of farm operations, forecasting farm operations, cropping patterns, average yield, customized package of practices.

In yet another embodiment, wherein the Sales Analysis module comprises functions selected from the group comprising sales plan schedule, product-wise sales analysis, cash and trade discounts, customer-wise analysis, output price trends, cost benefit analysis and expected cash flow schedule.

In another embodiment, the Budgetary Control module comprises functions selected from the group comprising variance standard and accounting cost of input for a period, variance standard and accounting cost of labor for a period, variance standard and accounting cost of input for each operation, variance standard and accounting cost of cultivation.

In yet another embodiment, the Funds Management module comprises functions selected from the group comprising funds requirement schedule, expected cash inflow schedule, funds borrowing schedule, expected cash flow schedule and cost of capital.

In still another embodiment, the Inventory Management module comprises functions selected from the group comprising purchase, scheme of holdings, average holdings and average holding period.

In another embodiment, the users are the Farmer, the Output Company, the Input company, the Input Dealer and the Output Trader.

In yet another embodiment, the central data warehouse is a world wide web server and the communication lines are Internet Lines that connect the different players of the system at their computers to the world wide web server.

In another embodiment, the system is capable of performing transactions between the Input Company and the Input Dealer, Output Company and the Output Trader, the Input Company and Farmer, Input Dealer and Farmer, Output Company and Farmer, Output Trader and Farmer.

In yet another embodiment, the system identifies an appropriate match for executing the transaction, in cases no match is identified or at the request of the user, the transactions/quotations are stored in the data-warehouse to be used by the user at a later stage.

The invention also provides a computer system for providing agricultural solutions and capable of effecting electronic commercial transactions, said system comprising:

a. A central processing unit (CPU) having data relating to a farm management system;

b. means for electronically linking the central processing unit with users, and

c. access means for electronic access to the CPU through the electronic linking means.

Further the invention provides a system wherein the means for electronically linking the CPU and the user is a network including internet.

In an embodiment, the means for access are computer located in remote places accessible to the users.

The decision support tools of the system comprise various modules or sub-modules that address specific farm activities such as soil analysis, nutrient management, water management, yield and harvest planning. The Crop Information means/System is a database of standard package of practices of various crops spread across various agro-climatic zones. FIG. 1 describes the scheme of the invention and FIG. 2 sets out the key players of the system.

The package is a Decision Support IT Tool which provides site-specific & situation-specific solutions and integrates all farm operations be it technical or commercial with an objective of optimally scheduling each of the activity and optimizing the cycle time which in turn, helps in optimal utilization of resources and yields better, accurate and precise results and also enables on-line commercial transactions.

Thus, the system of the invention primarily comprises 2 sub-systems

a)Farm Management System

b) Commerce

As opposed to the packages available in the market, which are discrete and address only a single important area such as precision farming or focused towards nutrient management, or skewed towards crops like soya, the invention proposes an integrated complete agricultural solution which provides a more comprehensive management control towards agriculture than others. The intention of the invention is to capture and integrate technical and commercial data for providing site specific technical and commercial solutions, so that it can be operated in different agro-climatic zones for a wide gamut of crops and wherein the in-built data warehouse contains crop wise and soil wise package of practices which are useful to the users The software is designed in such a manner that it provides a simple interface between the Farmer and the outside agencies and provides foolproof access privileges and security features. The main advantage of the invention is that it provides site specific technology/solutions. It enables easy scheduling of farm operations—technical and commercial, It helps in inventory management of the farm inputs and outputs. The software also enables budgeting of farm expenses, cash flow, cost benefit analysis, thereby providing an effective information and control system,

The Farm Management System provides information on crops, inventory management, funds management, sales analysis and budgetary control. Whereas the Commerce component enables transactions between a Farmer, the Input Company, Output Company, the Input Dealer and the Output Trader. These transactions between the players of the system can occur either at the same time or at different times i.e. all the players need not be present on the network at the same time. The transactions are conducted over a computer network that includes a central data warehouse, a number of distributed systems, and communication lines connecting the distributed systems to the central data warehouse. In a preferred embodiment, the central data warehouse is a world wide web server and the communication lines are Internet lines that connect the different players of the system at their computers to the world wide web server.

The key players in the Agri chain is the Farmer who is the producer, the Input Company, the Output Company, the Input Dealer and the Output Trader. The main objective and intention of this system is to bring all these players on a single platform and create a virtual marketplace, thereby enabling commercial transactions amongst them. The users of the system could range from the Farmer, organizations involved in corporate farming, Agricultural universities, Research organizations, Agri Output processing units, companies involved in sale of Agri Inputs, business chain intermediaries like the Dealers/Traders, rural refinancing/credit organizations, crop insurance agencies, market research companies, companies focussing on rural marketing, State and Central government, financial institutions and the like.

In fact, the present agricultural Agricultural System is a Synergistic Combination of a Farm Management System with electronical commerce and this system evolved out of a much efforts and inventive ingenuity of the inventors. The blend of the various aspects of farming and the novel approach of commercialization of the farm requirements has not been taught about so far and only now the inventors are able to come out with a workable and efficient method of managing agricultural operations. The Farming or farm Management itself is a difficult task having much uncertainties such as field conditions, whether conditions availability of other resources etc. In addition, the areas of approach is wide spread and difficult to access. Indeed, this system is worked or made operational effectively with an electronic system of commerce was never taught about due its inherent difficulties and problems. Only now, the applicants could successfully work out an integrated system which could provide all kinds of agricultural solutions from the producers to the end user and vice-versa.

Method of on-line transactions:

In accordance with the method of providing agricultural solutions as envisaged by the system, the user of the system, for instance, a Farmer, or the Output Company or the Dealer, etc registers itself as an user of the system. The User is provided with security and access privileges. In a particularly advantageous embodiment, the system includes creating an account for each user. The account will include details such as User Name, User Category and Password. The user may be located in any location and can access the system by interfacing with the world wide web. One of the main advantages of the package is that the user of the system can operate the system in a plurality of languages such as Hindi, Telugu, Punjabi, Kannada, English, Bengali etc.

If the user is a Farmer, he can obtain information on the crops that could be sown in the farm based on the soil properties and climatic conditions or the kind of fertilizers that can be used for his farm considering his the nature of his farm and the history of his farming practices. If the Farmer has his produce ready for sale, he can log into the system and quote a price at which he desires to effect the sale and the system will enable him to find a suitable purchaser at that price. Similarly, if an Output Company wants to purchase certain products from a Farmer, the system of the invention will enable him to find a suitable Farmer. Also the system will enable the Output Company to do transactions directly with the Farmer or the Input Company as the case may be. In case of transactions, the Central Computer receives the price, quantity and the kind of goods they wish to purchase and the Central Computer then tracks the most appropriate match and displays the same. The transaction may then be effected, if the match displayed is found acceptable.

In other words, the system enables transactions between the Input Company and the input Dealer, Output Company and the Output Trader, Input Company and the Farmer, Input Dealer and the Farmer, Output Company and the Farmer, Output Trader and the Farmer. Thus, the system enables Commerce between two entities. In the case of inputs, an Input Company as a User may provide details of the products manufactured or offered along with specifications and price. An Input Dealer, who acts as an intermediary in the entire business chain, also acting as a systems' User, would log on to the system simultaneously or at a different points of time and based on his requirements and specifications quote the quantity and acceptable price. Based on the query, the offer is interactively checked with the offers of the Input Companies, which data already exists within the system. Accordingly, the system identifies an appropriate match for executing the transaction. In cases where no match is identified, the quotations are stored in the data-warehouse.

An Output Trader is basically an intermediary between the Farmer and the Output Company or between two Output Traders. The Output Trader may act as an agent for consolidation of farm produce or a mere commission agent.

### BRIEF DESCRIPTION OF THE ACCOMPANYING DRAWINGS

FIG. 1 is a block diagram describing the scheme of the system of the invention.

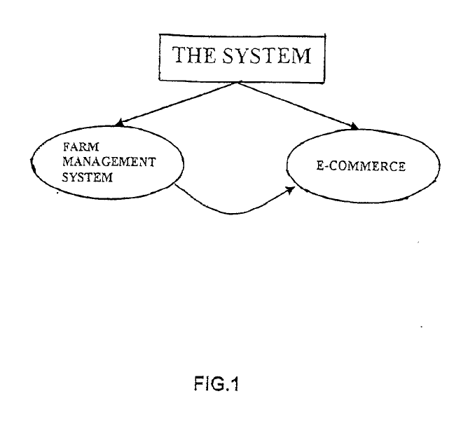

FIG. 2 is a block diagram describing the key players in the system.

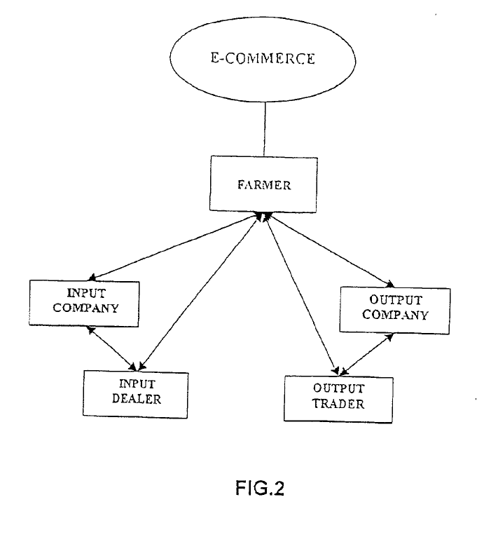

FIG. 3 sets out the different sub-system of the Farm Management System.

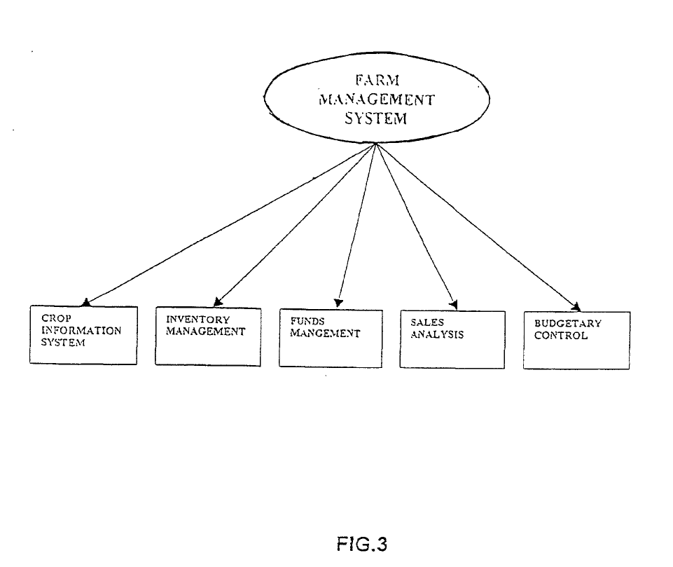

FIG. 4 describes the logic of the system.

FIG. 5 describes the central data warehouse of the system.

FIG. 6 describes the crops which it covers.

FIG. 7 describes the Overview of the Farm Management System

FIG. 8 describes a sample of the reports and logical mapping to the source.

FIG. 9 describes the Crop Information module.

FIG. 10 describes the Inventory Management module

FIG. 11 describes the Funds Management module.

FIG. 12 describes the Budgetary Control module.

FIG. 13 describes the Sales Analysis module.

### SCOPE OF THE SYSTEM

The Farm Management System primarily comprises of 6 modules and their working is described in detail herein below;

1. Crop Information System

This module is the bedrock of the package. It is in the form of an Agri Portal. It provides technical solutions—site-specific and situation-specific across individuals. The Crop Information module draws inputs from various data sources, in-built standard data and also primary data fed into the system by the Farmer. These data interact with the standard data to evolve the best-fit site-specific solutions.

The software caters to a larger number of crops such as cotton, paddy, pulses, maize, sugarcane, chillies, turmeric, soya, groundnut, sunflower, mango, grapes, banana and citrus spread across different weather patterns and soil types.

In agriculture, the season commences with the first activity being soil testing. Through the soil test the soil nutrient content is ascertained. Although the farmer has certain crop(s) in his mind, still based on the soil type, its content/deficiencies, inputs from remote sensing and information on cropping history certain crops are suggested. The commercial information software provides commercial information on these crops. The information is of the order of international prices, previous season's stock and futures markets of the commodity. Based on this information, the farmer can consult the decision support system to decide which crop to go for. He can accept any of the crop(s) suggested by the software or he can go for the crop of his choice.

The Package of Practices (POP) of the identified crop(s) is selected from the central data warehouse that has POPs for a gamut of crops. Based on the soil content, crop and variety the scheduling of each farm operation with Days After Sowing (DAS) being the reference is obtained. This schedule is translated into actual dates once the sowing takes place based on weather conditions. Also, based on the weather conditions which is captured in the input forms other details like irrigation requirements are altered. The software is dynamic in the sense that as the conditions change, the site-specific solutions also keep changing, in other words it provides situation-specific solutions.

The module also has scope for forecasting the farm output at every stage based on vegetative and reproductive parameters. The module suggests a standard POP and also records the actual POP followed by the farmer. At the end of the season a comparative statement showing the variance between the Standard POP and the Actual POP followed can be obtained.

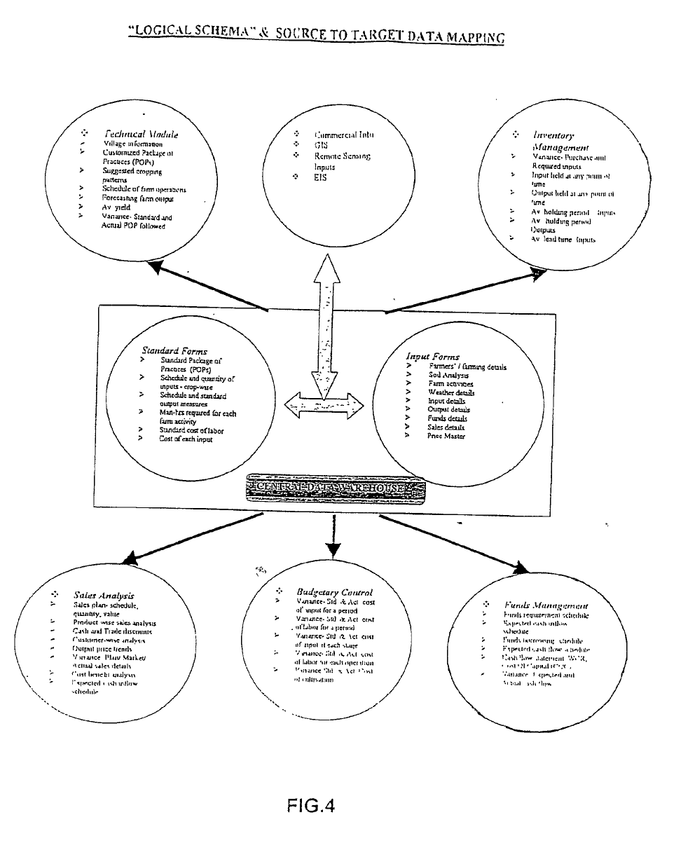

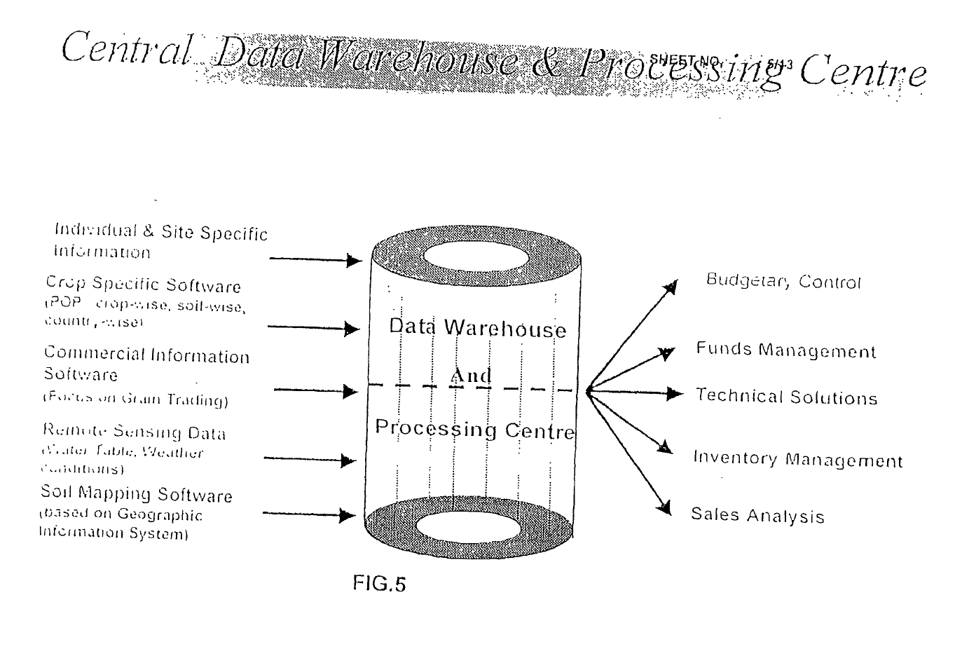

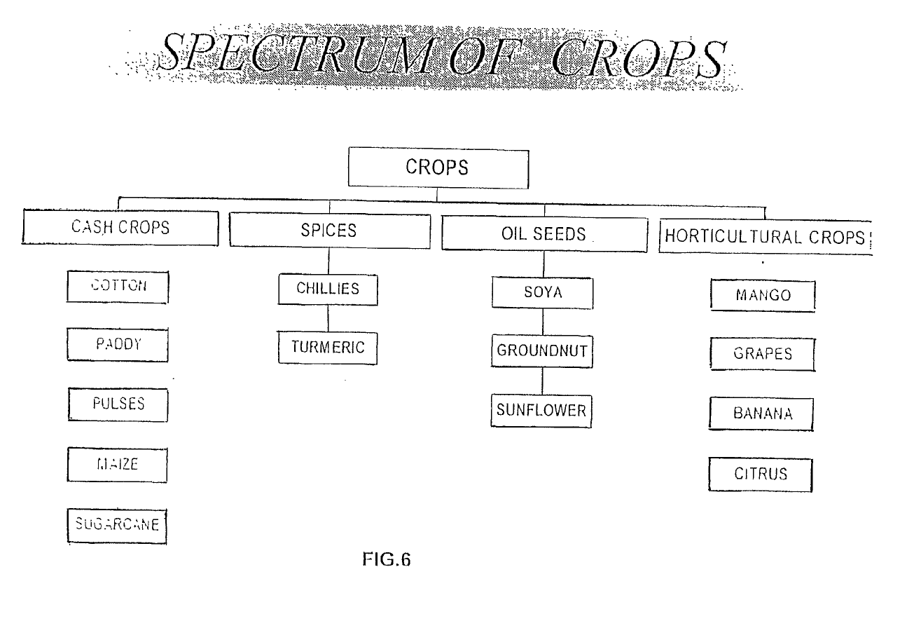

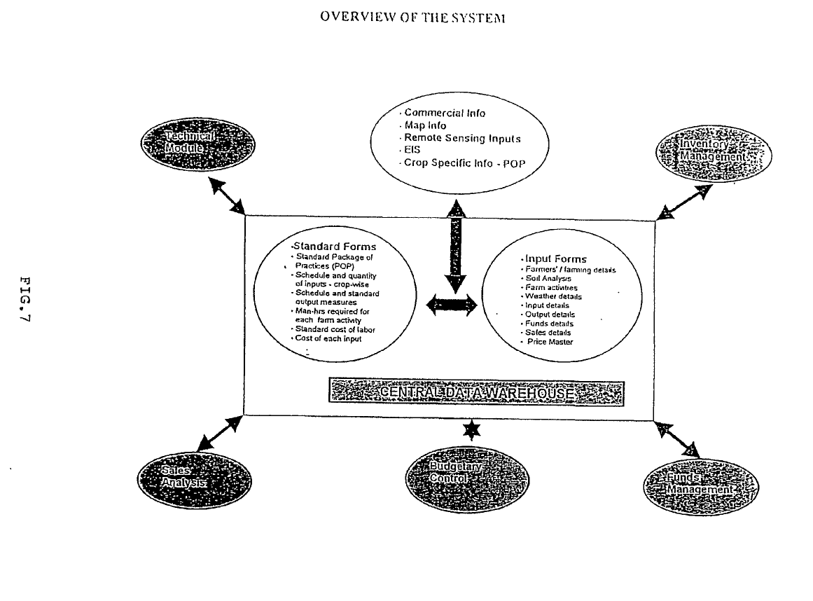

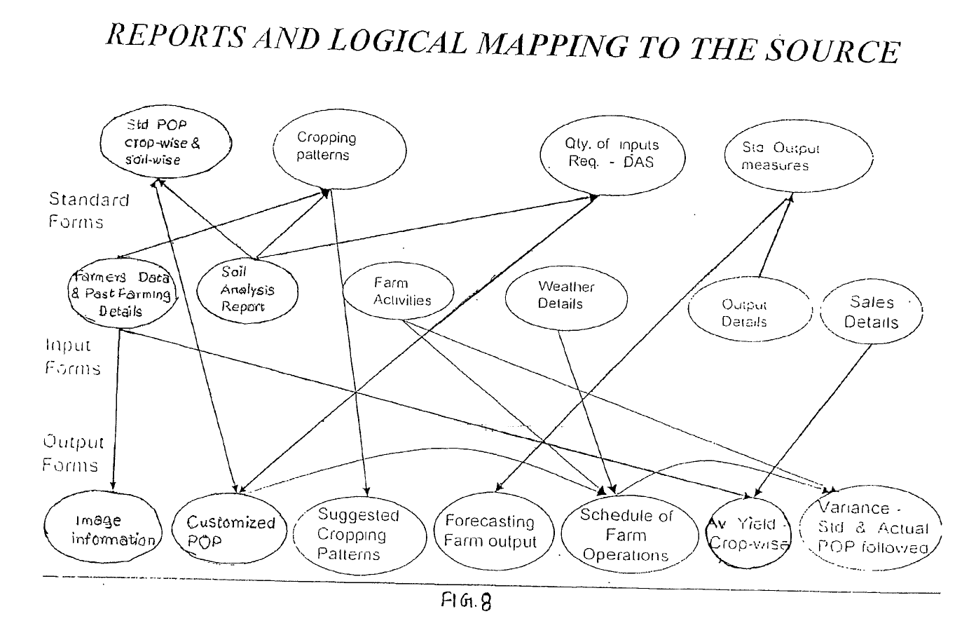

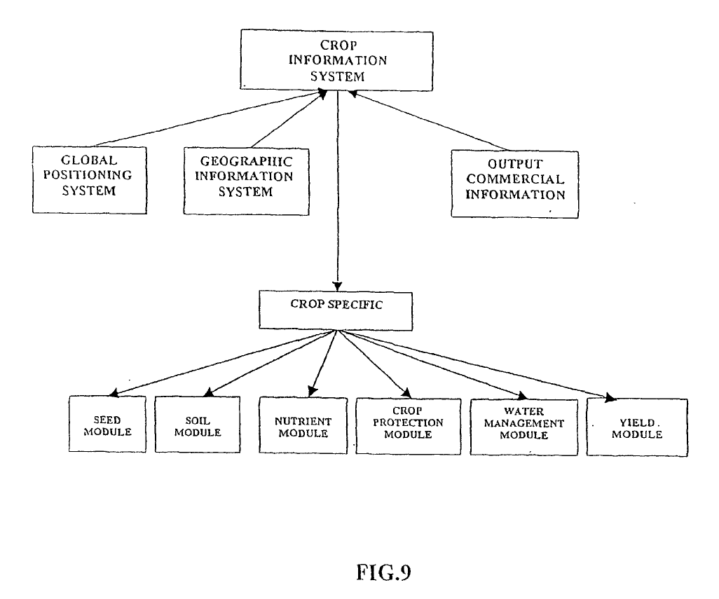

The Crop Information means/System module (as shown in FIGS. 4 to 9) provides site specific and situation-specific information for a gamut of crops in an array of languages based on the inputs from Geographic Information System and Global Positioning System. Based on the soil properties and the past cropping patterns, the possible crop rotations are suggested. The module will also enable a farmer to generate crop-wise and soil-wise reports based on the farmer's past farming history and soil analysis. The module will also suggests cropping patents, forecast farm output details, schedule of farm operations. The module can precise solutions and provide average yield crop-wise based on the farmer's farming history and sales details. Similarly, based an the farm activities, the schedule of farm operations can be regulated and managed using the module of the invention. This module has certain sub modules such as

Seed Module

This deals with the information of relating to seeds like the seed types and varieties It also consists of information like what kind of a seed is suitable for a particular soil type are agro-climatic zones.

Soil Module

This deals with the classification of soil types based on the results of the soil tests. Based on the composition and the soil content, this module suggests at to what are the soil properties and thereby the deficiencies in soil content based on the crop and variety chosen.

Nutrient Module

This deals with the decisions of nutrient management. Based on the soil test reports, the schedule and quantity of inputs required to be applied is suggested. These suggestions are site and situation specific based on inputs from Geographic Information System and Global Positioning System. These suggestions are not static but dynamic in nature and keep changing based on the situations.

Crop Protection Module

This deals with the decisions of pest management. Based on the weather conditions and the actual field conditions the chemicals to be applied are suggested along with schedules and quantities. These suggestions are also not static but dynamic in nature and keep changing based on the field situations.

Water Management

This deals with the issues of water management. Based on the irrigation source and soil moisture content the irrigation management practices are suggested along with schedules and quantities. These suggestions are also not static but dynamic in nature and keep changing based on the field situations. It also suggests the suggested means of irrigation based on crops and the irrigation source, such as, Drip Irrigation or Sprinkler Irrigation.

Yield Module

This module estimates the expected yield at any given point of time after a critical stage in the crop, the expected yield levels based on the vegetative and reproductive grows recorded. Also, it has provisions for recording the actual harvest details, both quantity-wise and data-wise.

2) Inventory Management

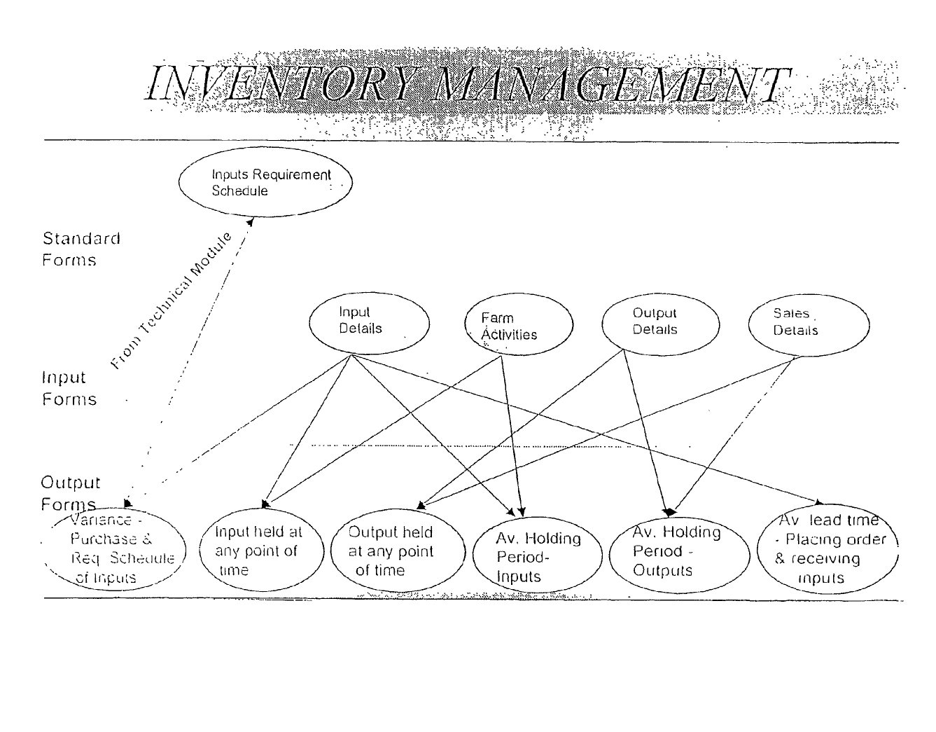

As shown in FIG. 10 this module basically deals with the management of inventory, both input and output. Based on the sowing details the actual dates of each operation and the quantities of inputs to be applied is known from the Crop Information module. The software also suggests the date on which the inputs could be potentially bought so that the inventory carrying cost is optimum. The date of harvest is also suggested. It also contains the harvest details, thereby, it can suggest solutions as to when is the optimum time to dispose the stock based on the market price, expected future price and the inventory carrying cost.

This module addresses the activities related to the stock and sale in case of farm output and stock and use/apply in the case of farm input.

The schedule of inputs requirement is an output from the CIS module. Based on the schedule of input requirement, the system suggests a schedule of input procurement. Once the farm input is procured, the details are keyed into the system. The farm activities are recorded in the technical module whereby the input application data as well as the quantities are recorded.

Similarly the dates and quantity of output harvested is recorded in the output details while the quantity and dates of sale of output are recorded in the sales details.

Based on the information which captures both the rate and the quantity dimensions of both the input and the output the inventory management is possible. This module enables decision-making based on the 6 basic reports.

It also gives report on the input and output held at any particular point of time as also the average holding period of both. It also provides report of the variance between the actual purchase of inputs and the suggested schedule of purchase. This module has certain sub-modules such as:

Input Details

This module deals with the schedule of purchase of farm inputs. It also records the data of placing of an order and the date of receiving the stocks.

Farm Activities

This module deals with the application of farm inputs in terms of both quantity and the dates of usage, individual input-wise.

Output Details

This module deals with the schedule of harvest of farm output. It records both the date and quantities of harvest crop-wise.

Sales Details

This module deals with the schedule of sales of farm output. It records the date of and quantity of sales of the output crop-wise.

3) Funds Management

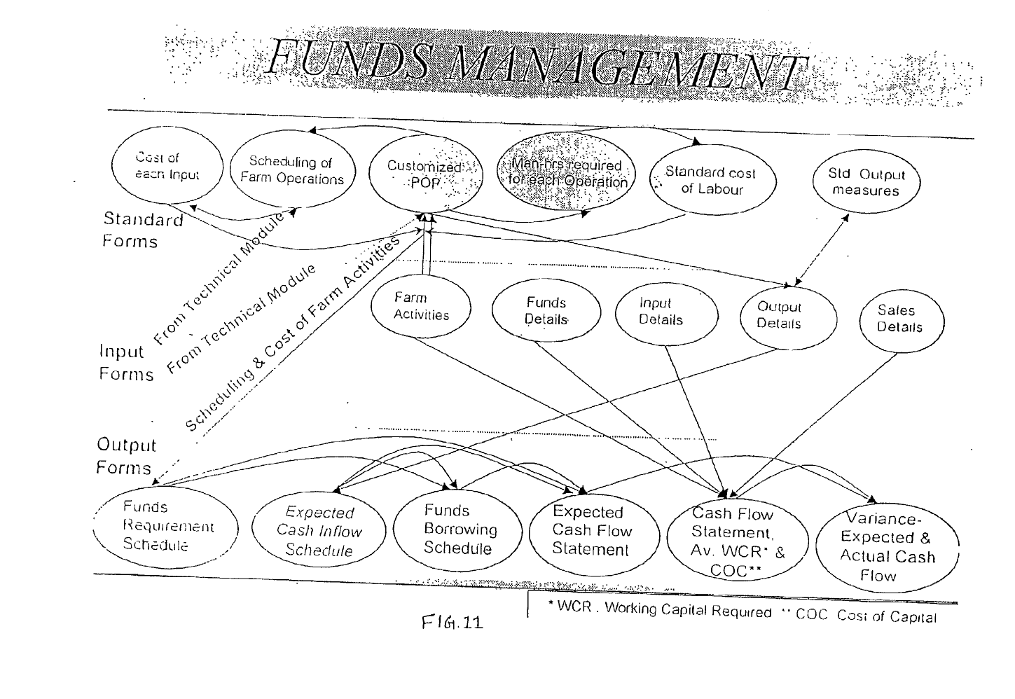

As shown in FIG. 11 this module basically deals with the management of cash. Based on the inputs from the Crop Information module as to the schedule of application of inputs and the schedule of purchase of inputs from the Inventory Management module, this module provides solution relating to the funds requirement schedule. Thereby, funds can be borrowed in a staggered manner based on requirement, so that the cost of capital is minimized. The suggested cash flow takes both the outflow based on the purchases as well as the cash inflow based on the proceeds accruing out of the schedule of sales of output.

For effective working of this module, the cost of the farm inputs such as equipments, etc., schedule of farm operations, man hours required for each operation, and standard cost of labor are some of the basic information that needs to be fed into the system by the user, so that the module will enable him to devise appropriate fund requirement schedule. Based on the farm activities, and the out-put details the cash inflow schedule can also be devised by the module. Further, based on the fund requirement schedule and the expected cash in-flow schedule, fund borrowing schedule can be generated. Similarly, based on the fund requirements, cash in-flow and the fund borrowing schedules, the module will enable the user to generate an expected cash flow statement. The details of the farm activities, fund details, input details and sales details if provided by the user, can be utilized by the module to generate an actual cash flow statement on the working capital required and the cost of capital. The expected cash flow statement and the actual cash flow statement are utilized by the module to generate a variance-expected and actual cash flow statements.

This module, thereby provides cash flow statements, average working capital requirements and the average cost of capital at any point of time as well as at the end of the season. It also provides report of the variance between the actual and the expected cash flows at every stage.

The schedule of farm operations is an output of the Crop Information System. The standard information in the system contains location specific costs of both manpower —activity-wise and also that of the inputs. Based on these two the actual costs of each operation, both material and manpower is calculated. This gives a cash outflow statement within a given time frame. Based on the capital availability and outflow schedule, the system generates a borrowing schedule and average working capital requirement.

The borrowing schedule also takes into consideration the cash inflow by way of expected sales realization of output obtained from the Crop Information module. The actual borrowings from different sources and also the rate of borrowing is recorded in the Fund details. The actual input purchase details are recorded in the input details while the out sales details are recorded in the sales details.

Thus based on these information reports such as Funds Requirement Schedule and Expected Cash Inflow Schedule can be obtained.

This module has certain sub-modules such as:

Funds Details

This module records the information pertaining to the funds. It records the schedule and amount of cash borrowed from different sources. It captures both the sources and the cost of capital of the borrowings.

Input Details

This module deals with value of farm inputs purchased along with the dates of purchase.

Sales Details

This module deals with value of farm output realized along with the dates of sales.

3) Sales Analysis

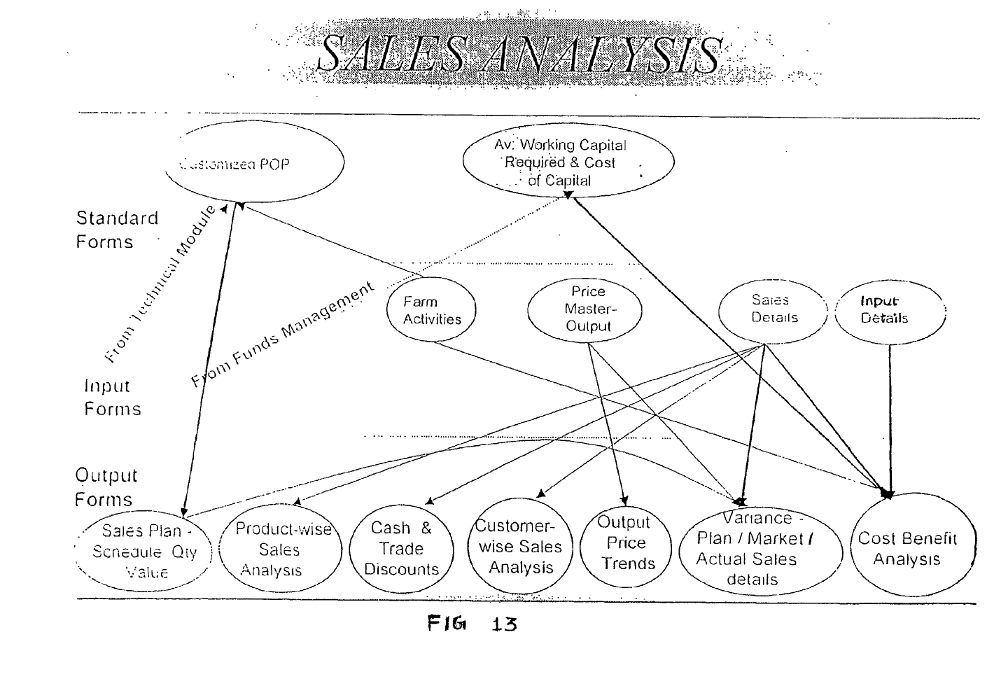

As shown in FIG. 13 this module basically deals with analysis of the sales of the output. It also provides output price trends. A Farmer can obtain product-wise sales analysis, if he has multi-products. Based on the Funds Management module and the Crop Information module, it suggests a schedule for sales.

At the end of the season cost benefit analysis reports can be obtained for each crop. It also has scope for recording the discounts, both trade and cash. It also provides a variance report of the sales details in terms of market price, expected price and the actual price realized.

Based on the actual farm activities like sowing, with interaction with the standard Package Of Practices contained in the Crop Information module, the date of harvest is suggested. Based on this and the expected price trends of the output, the sales schedule is suggested. The sales schedule's objective is to maximize the value realization of the output while optimizing the cost of capital.

The sales details in terms of quantity sold, date of sales and cash discounts and also the trade discounts provided are recorded. This module has certain sub-modules such as:

Price Master

This module records the price trends of a particular crop/output over the season location-wise.

Sales Details

This module records the terms of sale of the farm output, i.e., Cash and Trade discounts and the clients to whom the output had been sold and at what price.

4) Budgetary Control

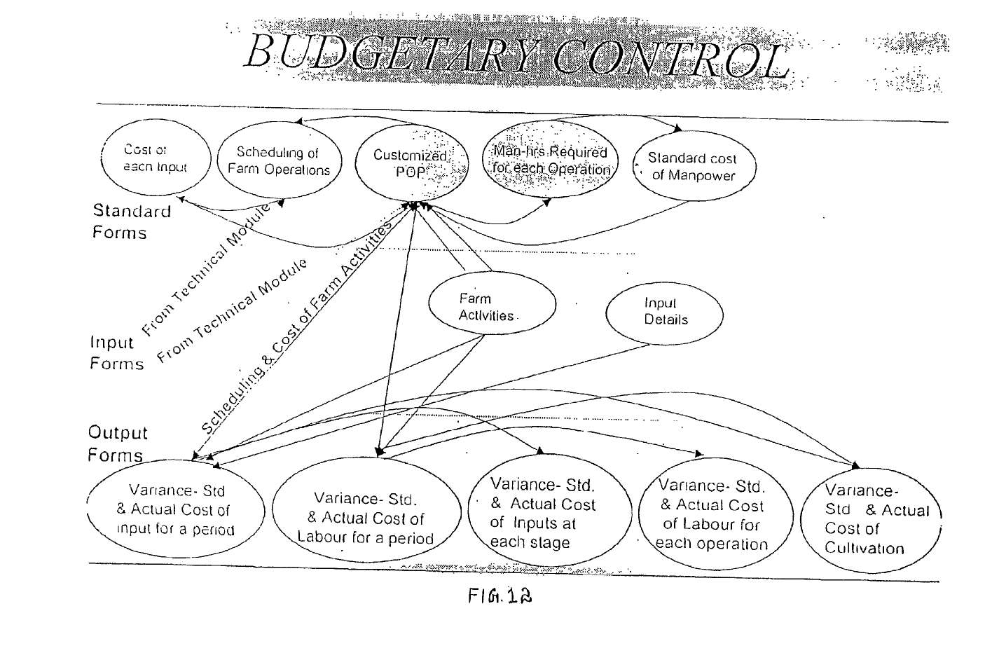

As shown in FIG. 12 this module basically deals with the management of expenses, both cost of inputs and that of labour and farm mechanization. It provides variance reports pertaining to standard and actual cost of inputs as also standard and actual cost of labour, activity-wise. These reports can be generated at any stage as also consolidated ones extracted at the end of the season,

There are duplication of sub-sub modules in some of the sub-modules but the fields capturing the data are different. In case of Budgetary Control the sub-sub modules are Input Details and Crop Information System.

5) E-Commerce

This module basically deals with the E-Commerce of both the farm inputs and the output. This module is capable of handling transactions. The gamut of possible users could be the Farmers, Input Companies, Input Dealers, Output Companies and Output Dealers.

The invention as described herein below contains several specificities, which should not be construed as limiting the scope of the invention, but as illustrative examples of the preferred embodiments of the invention. Several modifications of invention are possible. For instance, the modules and the sub-modules as envisaged and described in the invention may be devised as individual stand alone packages for specific use of an user. In other words, the modules could be slightly modified and turned around into stand alone packages to suit the needs of the specific user. Like, the technical module of the crop information system may be useful to a particular former and accordingly a package containing only this module could be devised.

In addition, the method described herein need not be conducted over the internet using a world-wide web server. The method is effective using any network that allows transmission of data between users at remote locations and a central processor. Similarly, modems are not necessary for working of the network. Many other methods of connection as known in the art of computer networking can be used, as shown in FIG. 10. Therefore, the scope of the invention should not be limited by the disclosure herein or the appended claims and their legal equivalents.

An example on bow the entire software operates as an integrated system

A farmer can access any of the modules separately or can access all of them as an integrated package. Below it is enumerated as an integrated package.

A farmer when he first accesses the system registers his name. Subsequently whenever he wishes to use the system, logs into the system and selects the language in which he wishes to operate. He selects his area of farming (agro-climatic zone/State). Then he feeds in his soil properties and the past cropping history in his field. Based on all these information the system suggests a crop and a variety based on the soil properties, the commercial output information, and the crop rotations previously followed. The former is at his liberty to go for the crop that is suggested by the system or he can go in for the crop that he is pre-decided on. Once the crop and the variety is decided, the farmer enters the information into the system.

The system also has Standard Information which are site specific, to be updated by the user. These relate to standard expenses of labour activity-wise, and also the location specific cost of the inputs. The package has in its Central Data Warehouse Standard Information related to crops—agro climatic zone-wise and also standard information relating to the labor required for each farm activity e.g. 10 man-hours required for ploughing 1 acre of land.

Based on the crop and the variety selected, the system suggests the schedule of farm activity which the farmer has to undertake. All the farm activities are scheduled with reference to the Days after Sowing (DAS) reference. This schedule gives the suggested date of each activity and also the quantities of inputs to be applied. The quantities are site-specific based on the soil properties and zone specific.

The first activity which a farmer takes up is the land preparation. As mentioned the system suggests a date for land preparation. For each of the activities a date is suggested. Once each activity is completed the data pertaining to it in terms of date of activity, costs and manpower employed is recorded.

For each of these activities the Crop Information System module provides information and specific queries can also be fired to which solutions would be provided. Specific information like, for e.g., if crop Rice is affected by some pests, then if one wishes to know about the pest or the chemicals to be applied to cure it, the information is available. Thus one can find information on topics such as crops, varieties, soil types, nutrients, pest, diseases, water management and weeds to name a few.

In a nutshell, the typical farm activities undertaken are Soil Analysis, Seed Treatment, Sowing, Integrated Nutrient Management, Integrated Pest Management, Water and Weed Management, Bio-Metric Observations, Plant Growth monitoring, purchase of farm inputs such as seeds, fertilizers and pesticides to name a Sew, in case of internal accruals not being sufficient, borrowing of fluids, harvest and sale of farm output.

For all these activities the date of each activity along with the details like source of borrowing, costs involved, repayment schedule are recorded. Based on all these the software acts as a decision support tool to facilitate effective decision making and provide solutions through a gamut of reports such as:

Village information

Customized Package of Practices (POP)—individual user-wise

Suggested cropping patterns

Schedule of farm operations

Forecasting farm output

Av.—yield—crop-wise

Variance—Standard and Actual POP followed

Variance—Purchase and Required schedule of inputs

Input held at any point of time

Output held at any point of time

Av. holding period—Inputs

Av. holding period—Outputs

Av. lead time—Placing order and Receiving inputs

Funds requirement schedule

Expected cash inflow schedule

Funds borrowing schedule

Expected cash flow schedule

Cash flow statement, av. working capital required and cost of capital

Variance—Expected and Actual cash flow

Sales plan—schedule, quantity, value

Product-wise sales analysis

Cash and Trade discounts

Customer-wise sales analysis

Output price trends

Variance—Plan/Market/Actual sales details

Cost benefit analysis—crop-wise

Expected cash inflow schedule

Variance—Standard and Actual cost of input for a period

Variance—Standard and Actual cost of labour for a period

Variance—Standard and Actual cost of input at each stage

Variance—Standard and Actual cost of labour for each operation

Variance—Standard and Actual cost of cultivation

A Typical Example:

1. User: Farmer

A farmer after doing soil analysis, ascertains the soil properties and finds that his soil is black soil which is suitable for growing cotton. On entering the soil properties details the Crop Information System module suggests 3 varieties, namely, RCH-2, JK-2 and MCU-5 which are suitable for growing in the existing soil conditions. The farmer then can chose one of the varieties based upon the Commercial Information System module which suggests the expected price trends based on the closing stock of previous year as also the existing price trends. On the basis of these information the farmer chooses JK-2 as the closing stock of previous year of RCH-2 and MCU-5 is higher and also the prices of these move cyclically and last year there had been a spurt in prices. So the current year the prices are expected to fall.

Once the farmer has chosen the variety JK-2, he enters the variety name in the system. Based on the local conditions the system suggest a date on which each activity could be undertaken. For, e.g., the system suggests as 1^{st} week of August as the date of sowing. For all subsequent farm operations a date with reference to the Days After Sowing (DAS) is suggested. For, e.g., 7 days after sowing is the date for basal application of 50 kgs of Urea, 15 days after sowing is the date of application of 25 kgs of Phosphorous, 45 days after sowing is the schedule for application of 5 kgs of Zinc (Micro-nutrient) and 60 days after sowing is the schedule for the first application of 5 liters of Monocrotophos.

These are site-specific Package of Practices. Once the actual sowing takes place and the details are entered, like date of sowing being August 3^{rd}, the schedule of all the suggested activities are converted into dates, now that the date of sowing is known. Lets assume the farmer applies on August 8^{th} 75 kgs of urea. After this information is entered into the system the recommendations based on the actual conditions might change. This is because the system provides site-specific and situation-specific information The recommendations are dynamic. Since the farmer has applied 75 kgs of Urea while the suggested quantity was 50 kgs, the subsequent recommendations would take this into account and thereby change accordingly. Previously, the 25 kgs of Zinc was recommended, after the Urea dosage has been entered the revised Zinc recommendation becomes 20 kgs.

if the farmer wants to find information about a particular farm input such as Micro-nutrient FeSO4 and the dosage to be applied for Cotton, he can through the hyperlinks arrive at the information. Also the farmer when he sees a particular pest having attacked his crop can obtain information about it. If the crop Cotton is affected by pest Stemborer, then he can find the information about Stemborer as also the disease which it could lead to i.e., Blast along with the information about the disease. Also the symptoms of the disease is provided as in Blast the symptom is White Ear Heads. Along with the information about the pest, diseases and the symptoms the chemicals which could check the pest and diseases is also provided, as in this case the chemical being Monocrotophos along with the recommended dosages 1 ml/liter.

This way issues relating to the entire agronomic practices are addressed. The system also captures the commercial information relating to the purchase and sale of Farm Inputs and Outputs respectively. When the farmer purchases Urea he enters the purchase information, say 100 kgs of it costing Rs. 450. Similarly he purchases, 50 kgs of Zinc, say at a price of Rs. 400. Along with the costs of inputs the cost of application are also entered, i.e., the labour costs. For applying urea in an acre of plot the cost is Rs. 35. Thereby, all costs are entered into the system in a similar fashion.

The system also captures the sources of fund and the schedule of borrowing and application of funds. The farmer borrows Rs. 5000 on August 10^{th} and another Rs. 5000 on 25^{th} September from two different sources at different rates of interest. The first Rs. 5000 he borrows from the local money lender at a rate of 24% per annum and the remaining Rs. 5000 from the local Bank at 14% per annum. All these information relating to the sources of fund are also captured by the system. The application of funds, mostly for purchase of inputs and performing farm operations are also captured.

Once harvest takes place, the output quantities, say 14 quintals of cotton are captured. Based on the price trends and also the interest costs on the funds borrowed a possible period of sales is also suggested. Lets say, 6 quintals on January 15^{th} and the balance 8 quintals on February 25^{th}. These details are also captured in the system which are the cash inflows.

2. E-Commerce

a. Farm Output

Once the crop has been harvested. The farmer may log into the system and fill in the details, such as:

| | |
|---|---|
| Category (Purchase/Sell) | Sell |
| Crop/Product | Cotton |
| Variety | JK-2 |
| Characteristics | 28 mm |
| Colour | White |
| Quantity | 100 quintals |
| Expected Price (Range) | Rs. 1950/quintal to |
| | Rs. 2000/quintal |

These details are checked iteratively with the information existing in the database and then matches are found. Incase no matches are found the details are stored in the central data warehouse.

| | |
|---|---|
| Category (Purchase/Sell) | Purchase |
| Crop/Product | Cotton |
| Variety | JK-2 |
| Characteristics | 28 mm |
| Colour | White |
| Quantity | 50 quintals |
| Expected Price (Range) | Rs. 1950/quintal to |
| | Rs. 1950/quintal |

An Output Company may log into the system and fill in the details:

An Output Trader may also log into the system and fill in the details:

| | |
|---|---|
| Category (Purchase/Sell) | Purchase |
| Crop/Product | Cotton |
| Variety | JK-2 |
| Characteristics | 28 mm |
| Colour | White |
| Quantity | 25 quintals |
| Expected Price (Range) | Rs. 1950/quintal to |
| | Rs. 1975/quintal |

Since there is a match between the expectation of both the buyer and the seller i.e. the Farmer, Output Company and the Output Trader, all the parties are brought together virtually for transactions to take place. This is done by each of the party being informed that based on their expectations parties have been identified and their contacts. These transactions can take place between:

Farmer and Output Company

Farmer and Output Trader

Output Trader and Output Company

Farmer, Output Company and Output Trader

b. Farm Input

In case of Farm Input different players access the system, The Input Company may log into the system and fill in the details, such as:

| | |
|---|---|
| Category (Purchase/Sell) | Sell |
| Crop/Product | Micro-nutrient |
| Variety | 23-23-0 |
| Characteristics | Powder |
| Colour | White |
| Quantity | 10,000 quintals |
| Expected Price (Range) | Rs. 8250/MT-Rs 8500/MT |

These details are checked iteratively with the information existing in the database and then matches are found. Incase no matches are found the details are stored in the central data warehouse.

An Input Dealer may log into the system and fill in the details:

| | |
|---|---|
| Category (Purchase/Sell) | Purchase |
| Crop/Product | Micro-nutrient |
| Variety | 23-23-0 |
| Characteristics | Powder |
| Colour | White |
| Quantity | 250 quintals |
| Expected Price (Range) | Rs. 8200/MT-Rs 8250/MT |

A Farmer may also log into the system and fill in the details:

| | |
|---|---|
| Category (Purchase/Sell) | Purchase |
| Crop/Product | Micro-nutrient |
| Variety | 23-23-0 |
| Characteristics | Powder |
| Colour | White |
| Quantity | 0.25 quintals |
| Expected Price (Range) | Rs. 8250/MT-Rs 8300/MT |

Since there is a match between the expectation of both the buyer and the seller i.e. the Farmer, Input Company and the Input Dealer, all the parties are brought together virtually for transactions to take place. This is done by each of the party being informed that based on their expectations parties have been identified and their contacts,

These transactions can take place between:

Input Company Farmer and

Input Company and Input Dealer

Input Dealer and Farmer

Farmer, Input Company and Input Dealer

1. An integrated system that provides agricultural solutions, enables on-line electronic business transactions, said system comprising:
i) A Farm Management System that comprises modules selected from the group of decision support tools consisting of Crop Information System, Budgetary Control, Funds Management, Inventory Management and Sales Management;
ii) Electronic commerce enabling system linked to the Farm Management System, and
iii) User interface enabling access to both, the Farm Management System and the electronic commerce enabling system.

2. A system as claimed in claim 1 wherein the Farm Management System modules selected from the group comprising Crop Information System, Funds Management, Sales Analysis, Budgetary Control and Inventory Management.

3. A system as claimed in claim 1 wherein the Crop Information module comprises sub-modules selected from the group consisting of seed module, soil module, nutrient module, crop production module, water management module and yield module.

4. A system as claimed in claim 1 wherein the Crop Information System comprises information relating to soil analysis, seed treatment, sowing, integrated nutrient management, integrated pest management, water and wheat management, bio-metric observations, plant growth monitoring and purchase of farm inputs such as seeds, fertilizers and pesticides.

5. A system as claimed in claim 1 wherein the Inventory Management module comprises sub-modules selected from the group comprising input details, farm activities, output details and sales details.

6. A system as claimed in claim 1 wherein Crop Information System provides information selected from suggestion of cropping pattern, schedule of farm operations, forecasting farm operations, cropping patterns, average yield, customized package of practices.

7. A system as claimed in claim 1 wherein the Sales Analysis module comprises functions selected from the group comprising sales plan schedule, product-wise sales analysis, cash and trade discounts, customer-wise analysis, output price trends, cost benefit analysis and expected cash flow schedule.

8. A system as claimed in claim 1 wherein the Budgetary Control module comprises functions selected from the group comprising variance standard and accounting cost of input for a period, variance standard and accounting cost of labor for a period, variance standard and accounting cost of input for each operation, variance standard and accounting cost of cultivation.

9. A system as claimed in claim 1 wherein the Funds Management module comprises functions selected from the group comprising finds requirement schedule, expected cash inflow schedule, funds borrowing schedule, expected cash flow schedule and cost of capital.

10. A system as claimed in claim 1 wherein the Inventory Management module comprises functions selected from the group comprising purchase, scheme of holdings, average holdings and average holding period.

11. A system as claimed in claim 1 wherein the users are the Farmer, the Output Company, the Input company, the Input Dealer and the Output Trader.

12. A system as claimed in claim 1 wherein the central data warehouse is a world wide web server and the communication lines are Internet Lines that connect the different players of the system at their computers to the world wide web server.

13. A system as claimed in claim 1 capable of performing transactions between the Input Company and the Input Dealer, Output Company and the Output Trader, the Input Company and Farmer, Input Dealer and Farmer, Output Company and Farmer, Output Trader and Farmer

14. A system as claimed in claim 1 wherein the system identifies an appropriate match for executing the transaction, in cases no match is identified or at the request of the user, the transactions/quotations are stored in the data-warehouse to be used by the user at a later stage.

15. A method for providing agricultural solutions and conducting electronic commercial transactions, said transactions being conducted over a computer network, comprising a central data warehouse and a plurality of remote computers/users, and communication lines connecting the remote computers/users to the central system, the method comprising the steps of:
a. registering as a user of the Farm Management System, wherein the system comprises information on decision support tools selected from crop information system, budgetary control, funds management, inventory management and sales management or Electronic Commerce;
b. requesting site specific information from any module of the decision support tool;
c. performing iterations in the database to provide solutions and enabling electronic transactions between users.

16. A method as claimed in claim 15 wherein the user account is created in the networking system providing each user a specific account name, identification code and password.

17. A method as claimed in claim 15 wherein the user accounts are created by the remote computers prior to using the system.

18. A method as claimed in claim 15 wherein the system is operable in languages selected from English, Hindi, Telugu, Kannada, Punjabi and Bengali.

19. A method as claimed in claim 15 wherein the central data warehouse is a world wide web server and the communication lines are Internet Lines that connect the different players of the system at their computers to the world wide web server.

20. A method as claimed in claim 15 wherein agricultural solutions are obtained though decision support tools comprises Farm Management System module selected from the group comprising Crop Information System, Funds Management, Sales Analysis, Budgetary Control and Inventory Management.

19. A method as claimed in claim 15 wherein agricultural solutions are obtained though decision support tools selected the group of modules comprising Crop Information module which further comprises sub-modules selected from the group consisting of seed module, soil module, nutrient module, crop production module, water management module and yield module.

20. A method as claimed in claim 15 wherein the Crop Information System comprises information relating to soil analysis, seed treatment, sowing, integrated nutrient management, integrated pest management, water and wheat management, bio-metric observations, plant growth monitoring and purchase of farm inputs such as seeds, fertilizers and pesticides.

21. A method as claimed in claim 15 wherein the Inventory Management module comprises sub-modules selected from the group comprising input details, farm activities, output details and sales details.

22. A method as claimed in claim 15 wherein Crop Information System provides information selected from suggestion of cropping pattern, schedule of farm operations, forecasting farm operations, cropping patterns, average yield, customized package of practices.

23. A method as claimed in claim 15 wherein the Sales Analysis module comprises functions selected from the group comprising sales plan schedule, product-wise sales analysis, cash and trade discounts, customer-wise analysis, output price trends, cost benefit analysis and expected cash flow schedule.

24. A method as claimed in claim 15 wherein the Budgetary Control module comprises functions selected from the group comprising variance standard and accounting cost of input for a period, variance standard and accounting cost of labor for a period, variance standard and accounting cost of input for each operation, variance standard and accounting cost of cultivation.

25. A method as claimed in claim 15 wherein the Funds Management module comprises functions selected from the group comprising funds requirement schedule, expected cash inflow schedule, funds borrowing schedule, expected cash flow schedule and cost of capital.

26. A method as claimed in claim 15 wherein the Inventory Management module comprises functions selected from the group comprising purchase, scheme of holdings, average holdings and average holding period.

27. A method as claimed in claim 15 wherein the users are the Farmer, the Output Company, the Input company, the Input Dealer and the Output Trader.

28. A method as claimed in claim 15 wherein the central data warehouse is a world wide web server and the communication lines are Internet Lines that connect the different players of the system at their computers to the world wide web server.

29. A method as claimed in claim 15 capable of performing transactions between the Input Company and the Input Dealer, Output Company and the Output Trader, the Input Company and Farmer, Input Dealer and Farmer, Output Company and Farmer, Output Trader and Farmer

30. A method as claimed in claim 15 wherein the system identifies an appropriate match for executing the transaction, in cases no match is identified or at the request of the user, the transactions/quotations are stored in the data-warehouse to be used by the user at a later stage.

31. A computer system for providing agricultural solutions and capable of effecting electronic commercial transactions, said system comprising:
a. A central processing unit (CPU) having data relating to a farm management system;
b. means for electronically linking the central processing unit with users, and
c. access means for electronic access to the CPU through the electronic linking means.

32. A system as claimed in claim 31 wherein the means for electronically linking the CPU and the user is a network including internet.

33. A system as claimed in claim 31 wherein the access means are computer located in remote places accessible to the users.
